(19) United States
(12) Patent Application Publication
(10) Pub. No.: US 2008/0033624 A1
(43) Pub. Date: Feb. 7, 2008

(54) Method for Reducing the Fuel Consumption of a Motor Vehicle

(75) Inventors: Ralph Gronau, Wetter (DE); Jurgen Woywood, Morfelden (DE)

Correspondence Address: CONTINENTAL TEVES, INC., ONE CONTINENTAL DRIVE, AUBURN HILLLS, MI, 48326-1581, US

(73) Assignee: CONTINENTAL TEVES AG &., oHG

(21) Appl. No.: 10/579,001

(22) PCT Filed: Nov. 12, 2004
(86) PCT No.: PCT/EP04/52939

§ 371 Date: Mar. 13, 2007

(30) Foreign Application Priority Data
Nov. 14, 2003 (DE) 103 53 335.4
Oct. 5, 2004 (DE) 10 2004 048 494.5

(51) Int. Cl. B60T 8/32

(52) U.S. Cl. 701/93

(57) ABSTRACT

In a method for reducing the fuel consumption of a motor vehicle, a driver's request for a uniform vehicle speed is determined and once this request for a uniform vehicle speed has been identified, the modifications to the vehicle speed, which are not initiated by the driver, are at least partly adjusted by control in order to obtain the lowest possible fuel consumption, for example of gasoline or diesel, for the driving engine of the vehicle.

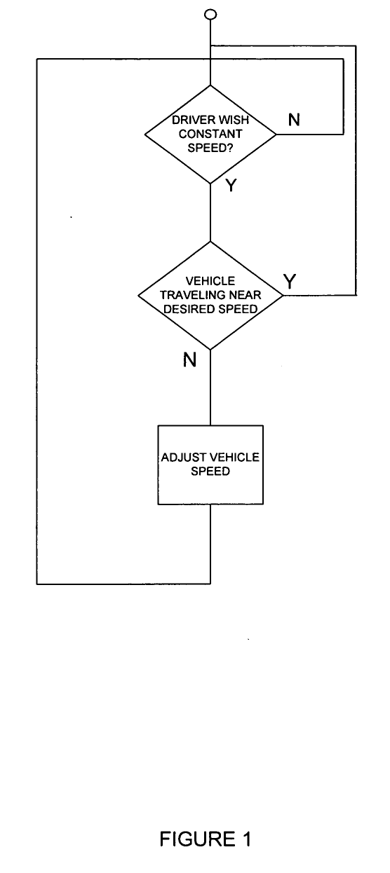

The present invention relates to a method for reducing the fuel consumption of a motor vehicle.

Due to constantly rising prices for energy, the fuel consumption of vehicles is of particular interest. A reduction of the fuel consumption of up-to-date vehicles gains in significance.

However, further developments of driving motors, reductions of air resistance or rolling resistance and other consumption-reducing improvements can only partly utilize the existing potential of a possible reduction in consumption.

Further, comparatively extensive economies are principally possible only with a fuel-saving type of driving.

An object of the invention involves improving vehicle control in terms of fuel-saving driving.

This object is achieved by the independent patent claims. Preferred embodiments are disclosed in the sub claims.

The object at issue is achieved in that a driver's request for a uniform vehicle speed is determined and once this request for a uniform vehicle speed has been identified, the modifications to the vehicle speed, which are not initiated by the driver, are at least partly adjusted by control in order to obtain the lowest possible fuel consumption, for example of gasoline or diesel, for the driving engine of the vehicle.

According to the invention, uniformity of driving is improved as an important factor of a fuel-saving style of driving. This means that acceleration and deceleration maneuvers shall be reduced to a necessary extent.

This method is implemented in a particularly preferred manner for vehicles with a gas direct injection system or a diesel engine as a driving engine which exhibit special advantages in terms of consumption in partial-load operation.

In addition, it is arranged for that the vehicle shall react as before (without consumption-optimized control according to the method of the invention) if the situation in traffic requires so and if it is the driver's desire.

On the whole, the driver is favorably not ‘forced’ by this solution to a generally different driving behavior. The automatic intervention into vehicle control by the method of the invention is not considered as a patronage of the driver, and it is easier for the driver to accept it.

It has shown that these provisions according to the invention support the driver in a field where even a skilled and foresighted driver has deficits in his/her behavior in terms of an optimal energy efficiency of the vehicle. What is more, the method not only improves the fuel consumption but also enhances driving comfort due to a more uniform vehicle speed.

It is arranged for by the invention that a change in the road resistance is determined and the road resistance change is at least partly adjusted by control.

It is provided by the invention that in determining the road resistance change, any change of the inclination of the roadway in the vehicle's longitudinal direction such as a road ascent or a road descent, or any change of weather conditions, in particular variable speeds of an atmospheric wind, or driving conditions such as variable angles of approach of the vehicle in the slipstream of another vehicle or object, and/or a cornering maneuver are taken into consideration.

It is arranged for by the invention that the driver's desire regarding a uniform vehicle speed is detected on the basis of the accelerator pedal movement (gas pedal movement).

It is hence possible to sensitively adjust speed variations which are not initiated by the driver by control, without the driver noticing such an action. Additional technical components are principally unnecessary to this end.

It is provided according to the invention that when a position of the accelerator pedal is constantly adjusted or maintained by the driver for a defined, predetermined time, a vehicle speed which results from this position of the accelerator pedal is identified as a desired speed reflecting the driver's request.

According to the invention, a period in the range of 1 second (sec) to 8 sec, preferably 5 sec approximately, is predetermined.

It is arranged for by the invention that the desired speed reflecting the driver's request is stored.

It is provided by the invention that the current vehicle speed is compared with the desired speed representative of the driver's request and, in the event of the current vehicle speed differing from the desired speed, the vehicle is automatically accelerated or deceleration or slowed down, respectively, in order to reduce the deviation, what is basically similar to a function of a cruise control with an option of brake intervention.

It is arranged for by the invention that the automatic acceleration or the automatic slowing down of the vehicle is performed in such a fashion that minimum possible fuel consumption, i.e. gasoline or diesel fuel, is needed for the driving engine of the vehicle.

According to another aspect of the invention, the vehicle can be automatically accelerated or automatically slowed down in such a manner that relatively insignificant acceleration or brake operations result for the driver, which are as comfortable as possible.

The invention arranges for the vehicle to be automatically accelerated or slowed down when the deviation of the current vehicle speed from the desired speed exceeds 0.2 km/h up to 2 km/h.

The invention will now be explained in detail by way of an embodiment.

A vehicle includes a vehicle regulation and control unit which can automatically influence the vehicle deceleration by ‘throttling down’ and/or ‘brake pressure buildup’ and the vehicle acceleration by ‘opening the throttle’ and/or ‘brake pressure reduction’.

Based on the knowledge that the driver wishes to cover the major part of the duration of travel (especially in long-distance driving) at a constant speed, the driver is supported in this aim, and unnecessary acceleration and deceleration operations are avoided.

Defined, frequently varying road resistance situations can counteract the driver's desire regarding constant travel in the course of driving.

When the driver strives for a constant speed and the road resistance changes slowly (due to an ascent or descent or wind, etc.), he/she will notice this fact only when a significant difference in speed (5 km/h up to 10 km/h) compared to the desired speed has occurred. The reason for this can be seen in the frequency of speed control (monitoring the speedometer), on the one hand, and in the visual resolving capacity of an analog speedometer, on the other hand. Likewise driving noises change only insignificantly with the discrepancies referred to hereinabove.

When the driver notices the deviation, he will try and readjust the previously adjusted desired speed, i.e., he accelerates the vehicle. As the vehicle speed has departed relatively far away from the desired speed, very much energy must be consumed then in order to readjust the desired speed.

Once the vehicle speed rises, e.g. during downhill driving, energy is removed due to an optionally initiated braking operation, which has initially been supplied to the system.

In addition, a transient effect around the desired speed can make the operation still more inefficient in both situations.

Thus, the changes of the road resistance have a large number of causes which can be sensed intuitively by the driver only in part.

The most obvious road resistance change is driving on an inclined roadway. In this case, too, an insignificant roadway inclination is mostly not noticed by the driver. According to the invention, this road resistance change is adjusted by control with the method of the invention.

The second important road resistance change, which cannot be sensed directly by the driver, is the change of the air resistance which can occur due to slipstreaming, or due to variable approach angles, and/or variable speeds of the atmospheric wind. This road resistance change is adjusted by control according to the method of the invention.

Road resistance is likewise increased due to a cornering maneuver and the related slip caused by king pin inclination. This increase is considered as insignificant. Likewise this road resistance change is adjusted by control according to the method of the invention.

The driver's desire of driving at a constant speed is realized according to the invention by monitoring the accelerator pedal position (pedal position).

When the driver constantly adjusts an accelerator pedal position for 1 to 8 seconds (sec), and deviations within a narrow band are not considered, this torque corresponding to the accelerator pedal position is adjusted by the engine's control unit. Now it is waited for until the vehicle speed has adjusted in conformity with the torque and will change no more.

The subsequently detected speed is stored. It is assumed according to the invention that this detected speed represents the desired speed.

If this is not the case, the driver will demand more torque by applying the accelerator pedal. The torque will no longer be constant in this case.

The current vehicle speed is constantly compared with the stored speed (desired speed). Once a deviation of 0.2 km/h to 2 km/h is detected, the engine torque will be modified in order to minimize this deviation, this implies to ‘adjust it by control’ in the sense of the invention.

The monitoring operation does not allow any deviations which become conspicuous to the driver. Therefore, the likelihood of an inefficient intervention by the driver is considerably reduced.

Accelerator pedal movements, i.e. vibrations of the accelerator pedal in excess of 1 hertz, that means movements more frequent than one time per second, are not taken into consideration with regard to changing the desired speed. These accelerator pedal movements are considered as a malfunction.

As the entire method is favorably designed in a rather passive fashion, the relatively short transitional times (delays) which may occur are not recognized by the driver.

Slow accelerator pedal movements are realized immediately because it is very likely that they do not imply a malfunction but represent a new request of the driver.

Likewise rapid accelerator pedal movements in one direction and with definite amplitude, which remain in one position in the end, will be realized immediately and regarded as a driver request after a short monitoring time.

The change of torque which is allowed due to the adjustment by control of the desired speed does not comprise the entire torque made available by the engine. Rather, only changes of ±10% up to ±40% of the initial torque (torque which prevailed when the desired speed was stored) are admitted. This renders it always possible to the driver to accelerate actively or generate a stall torque.

Further, the invention provides a limitation of the speed range in which the function according to the invention is performed. The main economy potential lies with higher speeds (higher than 60 km/h up to 70 km/h). Constant rides are more frequent in these speed ranges than city rides. Therefore, the method is preferably implemented at vehicle speeds exceeding roughly 60 km/h up to 70 km/h.

1-10. (canceled)

11. A method of reducing fuel consumption in a motor vehicle, the method comprising:
determining a request from a driver for a uniform vehicle speed; and
after identifying the request for uniform vehicle speed, at least partly controlling modifications to the vehicle speed, which are not initiated by the driver, in order to obtain a lowest possible fuel consumption for the driving engine of the vehicle.

12. A method according to claim 11, wherein a change in a resistance of travel is determined and the travel resistance change is at least partly adjusted by control.

13. A method according to claim 12, wherein in determining the travel resistance change, any change of an inclination of travel in longitudinal direction of the vehicle, such as a road ascent or a road descent, or any change of weather conditions, in particular variable speeds of an atmospheric wind, or driving conditions such as variable angles of approach of the vehicle in the slipstream of another vehicle or object, or a cornering maneuver are taken into consideration.

14. A method according to claim 11, wherein the request from the driver for uniform vehicle speed is detected on the basis of the accelerator pedal movement.

15. A method according to claim 14, wherein when a position of the accelerator pedal is constantly adjusted or maintained by the driver for a defined, predetermined time, a vehicle speed which results from this position of the accelerator pedal is identified as a desired speed reflecting the request for uniform vehicle speed.

16. A method according to claim 15, wherein a period in a range of 1 second to 8 sec is predetermined.

17. A method according to claim 15, wherein the desired speed reflecting the request for uniform speed is stored.

18. A method according to claim 17, the current vehicle speed is compared with the desired speed representative of the driver's request and, in the event of the current vehicle speed differing from the desired speed, the vehicle is automatically accelerated or deceleration or slowed down, respectively, in order to reduce the deviation.

19. A method according to claim 18, wherein an automatic acceleration or automatic slowing down of the vehicle is performed in such a fashion that minimum possible fuel consumption is needed for the driving engine of the vehicle.

20. A method according to claim 18, wherein the vehicle is automatically accelerated or slowed down when the deviation of the current vehicle speed from the desired speed exceeds 0.2 km/h up to 2 km/h.
